(19) United States
(12) Patent Application Publication
(10) Pub. No.: US 2005/0268457 A1
(43) Pub. Date: Dec. 8, 2005

(54) Apparatus and method for mounting electronic components

(76) Inventors: Hiroshi Ebihara, Moriguchi-shi (JP); Ken Kobayashi, Hirakata-shi (JP); Hiroshi Nasu, Neyagawa-shi (JP); Daido Komyoji, Ikoma-shi (JP)

Correspondence Address: WENDEROTH, LIND & PONACK L.L.P., 2033 K. STREET, NW, SUITE 800, WASHINGTON, DC, 20006, US

(21) Appl. No.: 11/111,935

(22) Filed: Apr. 22, 2005

(30) Foreign Application Priority Data
May 10, 2004 (JP) 2004-139576

(51) Int. Cl. B23P 19/00

(52) U.S. Cl. 29/740; 29/742; 29/744

(57) ABSTRACT

The electronic component mounting apparatus has a board holding part for holding a circuit board, a mounting mechanism for mounting an electronic component on the circuit board, and a grinding part for grinding a suction surface of a suction nozzle of the mounting mechanism. After mounting of the electronic components on the circuit board are repeated a predetermined number of times, the suction surface is ground. In the electronic component mounting apparatus, by continuously moving the suction nozzle in the Y-direction relative to the grinding part and moving the suction nozzle up and down, and bringing the suction surface of the suction nozzle in intermittent contact with the grinding surface of the grinding member with ultrasonic vibrations applied, the suction surface can be ground while preventing the occurrence of a large deformation of the suction nozzle.

### TECHNICAL FIELD

The present invention relates to an electronic component mounting apparatus and method for mounting electronic components on a circuit board.

### BACKGROUND OF THE INVENTION

Conventionally, in an apparatus for mounting electronic components on a circuit board such as a printed board or the like, various methods for connecting electrodes of the electronic components with electrodes of the circuit board are used, and a bonding method utilizing ultrasonic waves (hereinafter referred to as “ultrasonic bonding”) as one of the methods capable of bonding electronic components in a short time and at a comparatively low temperature is known. According to the ultrasonic bonding, the electronic component pressurized against the circuit board is vibrated by ultrasonic vibrations, so that the electrodes of the electronic component on which, for example, bumps are formed and the electrodes of the circuit board are electrically connected with each other.

In such the electronic component mounting apparatus for carrying out the ultrasonic bonding, as the result of the abrasion of a suction surface of a holding portion that sucks and holds the electronic component due to friction with electronic components and the adhesion of foreign materials to the suction surface, the characteristics of the suction surface are changed from the ideal state, or the sucked electronic component is disadvantageously inclined with respect to the circuit board. Accordingly, a technique for regenerating the abraded suction surface and a technique for removing the foreign materials that adhere to the suction surface, are proposed.

For example, JP 2000-91385 A discloses a technique for regenerating the suction surface to a predetermined surface roughness in a short time by moving an abrasive brought in contact with the suction surface while applying ultrasonic vibrations to the holding portion. Moreover, a technique for removing the adhering matters on the suction surface by applying ultrasonic vibrations to the holding portion in a state in which the surface regenerated by the abrasive is immersed in a cleaning solution is also disclosed.

In the mounting apparatus disclosed in the JP 2000-91385 A, the grinding of the suction surface is continuously effected by moving the abrasive in the state in which the holding portion is brought in contact with the abrasive for a comparatively long time, and therefore, it is concerned that a large bending stress may be applied to the holding portion depending on the shape of the holding portion and disadvantageously largely deformed. Moreover, it is also possible that the abrasive powder generated during the grinding might adhere to the suction surface at the next time of grinding and damage the suction surface when it is attempted to save the consumption of the abrasive. Furthermore, because of the provision of a cleaning bath or the like for cleaning the suction surface in addition to a support portion that supports the abrasive, it has been difficult to achieve the simplification of the apparatus.

The present invention has been made in view of the above problems and has an object to provide an electronic component mounting apparatus and method capable of grinding the suction surface while preventing the occurrence of a large deformation of the component holding member.

### SUMMARY OF THE INVENTION

In order to achieve the above object, the present invention is constructed as follows.

According to a first aspect of the present invention, there is provided an electronic component mounting apparatus for mounting an electronic component on a circuit board, the apparatus comprising:

a component holding member configured to suck and hold the electronic component with a suction surface, and mount the electronic component on the circuit board;

a grinding member configured to have a grinding surface;

an elevating mechanism configured to move up and down the component holding member and the grinding surface relative to each other;

a moving mechanism configured to move the component holding member and the grinding surface relative to each other in mutually parallel movement directions; and

a control part configured to bring the suction surface in intermittent contact with the grinding member while moving the component holding member and the grinding member relative to each other in the movement directions by controlling the elevating mechanism and the moving mechanism.

According to the above construction, the suction surface of the component holding member and the grinding member are brought in contact with each other by moving the component holding member and the grinding member in the mutually parallel movement directions. Therefore, the suction surface can be ground while preventing the occurrence of the large deformation of the component holding member.

The electronic component mounting apparatus may be designed so that the apparatus further comprises an oscillation part configured to apply vibrations to the component holding member, and the control part controling the oscillation part to bring the suction surface in intermittent contact with the grinding member and apply vibrations to the component holding member.

By further applying vibrations to the component holding member by the oscillation part, the grinding of the suction surface can be performed more effectively.

The electronic component mounting apparatus may be designed so that the grinding member has a sheet-like shape, and the apparatus further comprises a grinding member holding part configured to have a flat surface portion to be brought in contact with a center portion of the grinding member used for grinding and a suction portion configured to suck and hold the grinding member by a periphery of the center portion.

With the above construction, the grinding member can be held easily and reliably, and the grinding of the suction surface can be performed more accurately.

The electronic component mounting apparatus may be designed so that the oscillation part is an ultrasonic vibrator, and

the elevating mechanism pressurizes the electronic component held by the component holding member against the circuit board, and the ultrasonic vibrator applies ultrasonic vibrations to the electronic component when the electronic component is connected electrically to the circuit board.

The oscillation part used for the grinding of the suction surface is used also in mounting the electronic components on the circuit board, and therefore, the construction of the electronic component mounting apparatus can be simplified.

The electronic component mounting apparatus may be designed so that the movement direction coincides with a direction in which the suction surface vibrates.

With the above construction, the occurrence of the large deformation of the component holding member can more reliably be prevented.

The electronic component mounting apparatus may be designed so that the electronic component is a semiconductor light-emitting device.

Further, according to a second aspect of the present invention, there is provided an electronic component mounting method for mounting an electronic component on a circuit board, the method comprising:

mounting the electronic component on the circuit board by a board holding member that sucks and holds the electronic component with a suction surface at which an inlet is formed; and

bringing the suction surface in contact with a grinding member while moving the grinding member that has a grinding surface configured to grind the suction surface and the component holding member relative to each other in mutually parallel directions while mounting operation of the electronic component is repeated.

Also, according to a second aspect, the suction surface of the component holding member and the grinding member are brought in contact with each other by moving the component holding member and the grinding member in the mutually parallel movement directions as in accordance with the first aspect. Therefore, the suction surface can be ground while preventing the occurrence of the large deformation of the component holding member.

The electronic component mounting method of the second aspect may be designed so that the vibrations are applied to the component holding member when the suction surface is brought in contact with the grinding member.

By further applying vibrations, the grinding of the suction surface can be performed more effectively.

The electronic component mounting method of the second aspect may be designed so that a gas is blown from the inlet toward the grinding member immediately before the suction surface is brought in contact with the grinding member.

By this operation, the foreign materials existing on the grinding member are blown off by the gas, and therefore, the foreign materials can be prevented from adhering to the suction surface during the grinding.

The electronic component mounting method of the second aspect may be designed so that suction through the inlet is carried out immediately after the gas is blown and immediately before the suction surface is brought in contact with the grinding member.

By further effecting suction, the foreign materials can be removed from the grinding member, and therefore, the foreign materials can be prevented from adhering to the suction surface during the grinding.

### BRIEF DESCRIPTION OF THE DRAWINGS

These and other aspects and features of the present invention will become clear from the following description taken in conjunction with the preferred embodiments thereof with reference to the accompanying drawings, in which:

FIG. 1 is a front view showing the construction of an electronic component mounting apparatus according to an embodiment of the present invention;

FIG. 2 is a plan view of the electronic component mounting apparatus shown in FIG. 1;

FIG. 3 is an enlarged view of a suction nozzle and its neighborhood in the electronic component mounting apparatus shown in FIG. 1;

FIG. 4 is a flow chart showing the flow of the operation of the electronic component mounting apparatus shown in FIG. 1;

FIG. 5 is a flow chart showing the flow of the operation of the electronic component mounting apparatus shown in FIG. 1;

FIG. 6 is a flow chart showing the grinding operation executed by the electronic component mounting apparatus shown in FIG. 1; and

FIG. 7 is a view for explaining the state of the electronic component placed on a component tray in the electronic component mounting apparatus shown in FIG. 1.

### DETAILED DESCRIPTION OF THE PREFERRED EMBODIMENTS

Embodiments of the present invention will be described in detail with reference to the drawings. The same constituent parts in the figures are denoted by the same reference numerals.

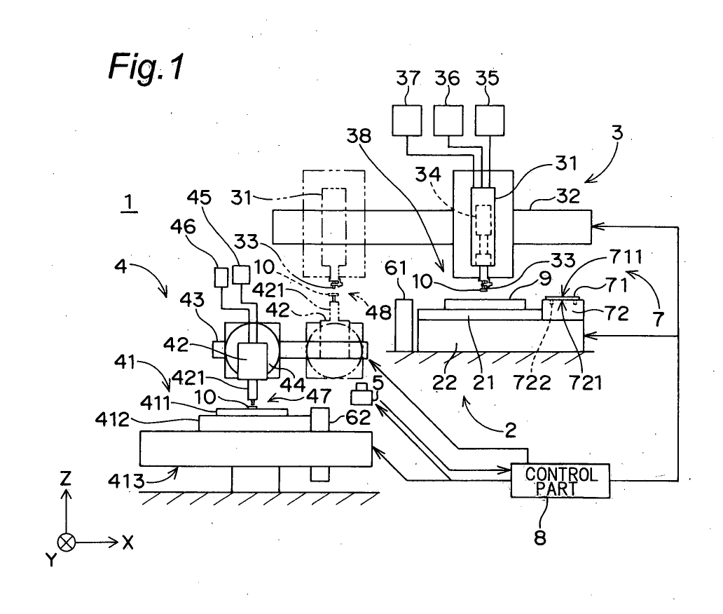

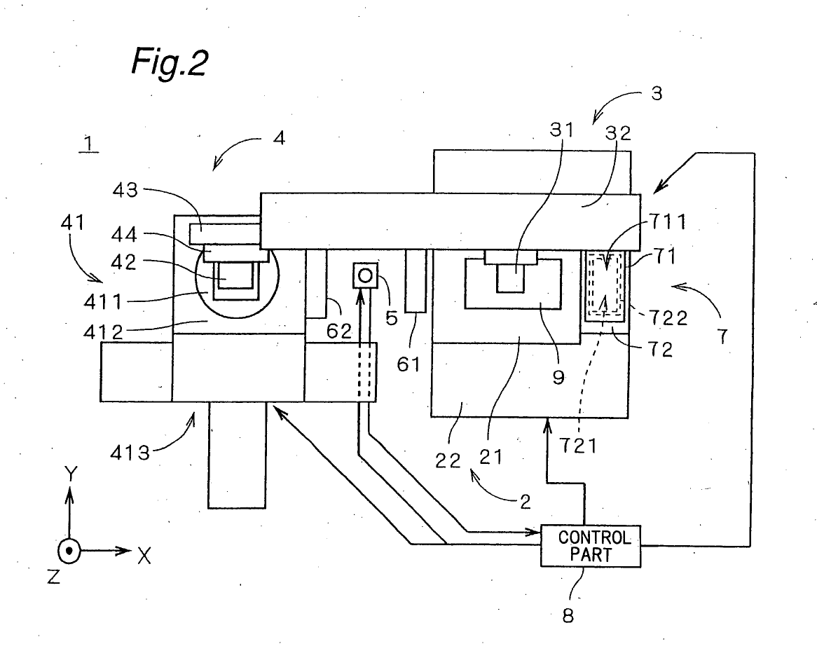

FIG. 1 is a front view showing the construction of an electronic component mounting apparatus 1 according to one embodiment of the present invention, and FIG. 2 is a plan view of the electronic component mounting apparatus 1. The electronic component mounting apparatus 1 is a so-called flip-chip mounting apparatus, which turns round a minute electronic component 10 and thereafter concurrently carries out the mounting of the electronic component 10 on a circuit board 9 such as a printed board or the like and the bonding of the electrodes, i.e., mounting.

The electronic component mounting apparatus 1 has a board holding part 2 that holds the circuit board 9. A mounting mechanism 3 for mounting the electronic component 10 on the circuit board 9 held by the board holding part 2 is provided on the (+Z) side of the board holding part 2, i.e., on the upper side. A component feeding part 4 for feeding the electronic component 10 to the mounting mechanism 3 is provided on the (−X) side of the board holding part 2, i.e., on the left-hand side in the figure. Moreover, an image pickup part 5 for picking up the images of the electronic component 10 fed to the mounting mechanism 3 by the component feeding part 4 and component collecting mechanisms 61 and 62 for collecting the electronic component 10 are provided between the board holding part 2 and the component feeding part 4. A grinding part 7 for grinding an end of a suction nozzle 33 of the mounting mechanism 3 that holds the electronic component 10 is provided on the (+X) side of the circuit board 9, i.e., on the right-hand side in the figure. In the electronic component mounting apparatus 1, the electronic component 10 is mounted on the circuit board 9 by driving these mechanisms under the control of a control part 8.

The board holding part 2 has a stage 21 for holding the circuit board 9 and a stage moving mechanism 22 for moving the stage 21 in the Y-direction in FIG. 1. The grinding part 7 is provided on the (+X) side of the stage 21 and moves in the Y-direction integrally with the stage 21 by the stage moving mechanism 22.

The grinding part 7 has a sheet-shaped grinding member 71 that has a flat grinding surface 711 perpendicular to the Z-direction and a grinding member holding part 72 that holds the grinding member 71. The grinding member holding part 72 has a flat surface portion 721 with which a center portion of the grinding member 71 used for grinding the suction nozzle 33 comes in contact and a groove-shaped suction portion 722 formed at the periphery of the flat surface portion 721, and the suction portion 722 aspirates by suction the grinding member 71 at the periphery of the center portion of the grinding member 71. With the above arrangement, the grinding member 71 is detachably held by the grinding member holding part 72.

The mounting mechanism 3 has a mounting head 31 and a mounting head moving mechanism 32 for moving the mounting head 31 in the X-direction, and the mounting head 31 has the suction nozzle 33 that corresponds to a component holding member for holding by suction the electronic component 10. The mounting head 31 has a nozzle elevating mechanism 34, which moves the suction nozzle 33 in the Z-direction, i.e., moves up and down the nozzle.

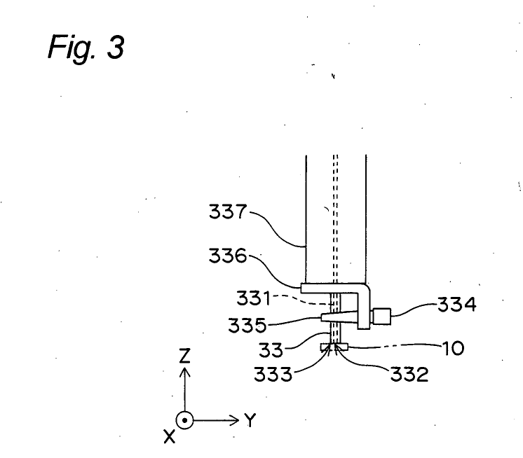

FIG. 3 is an enlarged view showing the suction nozzle 33 and its neighborhood. The suction nozzle 33 has a suction passage 331 for vacuum suction provided in the center portion and sucks and holds the electronic component 10 on a suction surface 333 by carrying out suction from an inlet 332 formed at the end suction surface 333. Moreover, it is also possible to blow air of a gas through the inlet 332 by sending compressed air from a compressed air source 35 into the suction passage 331 of the suction nozzle 33. The mounting head 31 is provided with a pressure sensor 36, which makes it possible to detect whether or not the suction nozzle 33 is holding the electronic component 10. Moreover, the mounting head 31 is also provided with a load sensor 37, which makes it possible to detect the load applied to the suction nozzle 33 and the electronic component 10.

An ultrasonic vibrator 334, which corresponds to an oscillation part that applies ultrasonic vibrations to the suction nozzle 33 via a horn 335, is attached to the suction nozzle 33. It is noted that the ultrasonic vibrations mean vibrations in a frequency band of not lower than 16 kHz. The suction nozzle 33, the horn 335 and the ultrasonic vibrator 334 are attached to a shaft 337 via a block 336, and the suction nozzle 33 is moved up and down relative to the grinding surface 711 by moving the shaft 337 in the Z-direction by the nozzle elevating mechanism 34. Moreover, the suction nozzle 33 is moved relative to the grinding surface 711 by the stage moving mechanism 22 in a Y-direction that is a predetermined movement direction parallel to the grinding surface 711.

The component feeding part 4 has a component placement portion 41 that places the electronic component 10 at a predetermined position, a feeding head 42 that takes an electronic component 10 out of the component placement portion 41 and holds the component, a feeding head moving mechanism 43 that moves the feeding head 42 in the X-direction, and a turn mechanism 44 that turns the feeding head 42. The component placement portion 41 has a component tray 411 on which numbers of electronic components 10 are placed, a stage 412 that holds the component tray 411 and a tray moving mechanism 413 that moves the component tray 411 together with the stage 412 in the X-direction and the Y-direction.

The feeding head 42 has a feeding collet 421 (see FIG. 1) that feeds the electronic component 10 held by suction to the suction nozzle 33 of the mounting head 31. The feeding collet 421 has a suction passage for vacuum suction in the center portion and sucks and holds the electronic component 10 by carrying out suction through the inlet formed at the end of the collet. The feeding head 42 is provided with a pressure sensor 45, which makes it possible to detect whether or not the feeding collet 421 is holding the electronic component 10. Moreover, by sending compressed air from a compressed air source 46 into the suction passage of the feeding collet 421, it becomes possible to blow air from the inlet. The feeding collet 421 can advance and retreat in a direction apart from the main body of the feeding head 42 by a mechanism provided inside the feeding head 42, i.e., on the (−Z) side.

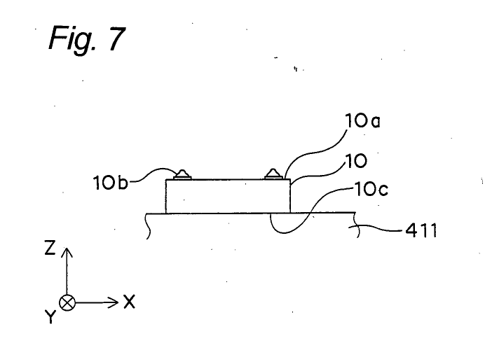

In the component feeding part 4, as shown in FIG. 7, numbers of electronic components 10 to be mounted on the circuit board 9 are placed on the component tray 411. Each of the components is arranged in a state of turning a face on which electrode portions 10b to be bonded to the circuit board 9, i.e., a lower surface 10a (hereinafter referred to as a “bonding surface”) in the mounted state are formed toward the (+Z) side. The direction of the (+Z) side is opposite from the direction in which the components are mounted on the circuit board 9. In the present embodiment, the electrode portions 10b of the electronic component 10 are ball bumps formed of gold (Au) on an electrode pattern. However, depending on the mounting method or the electronic component to be mounted, the electrode portions 10b may be plating bumps or the like or the electrode pattern itself. Moreover, bumps may be provided on the electrodes of the circuit board 9 instead of being provided on the electrode pattern of the electronic component 10.

The image pickup part 5 is provided at a position where it does not interfere with the movement of the mounting head 31 by the mounting head moving mechanism 32 and, in particular, on the movement pathway of the suction nozzle 33 or just below the movement pathway in the present embodiment. The image pickup part 5 picks up the images of the electronic component 10 held by the suction nozzle 33 on the (—Z) side. The component collecting mechanism 61 provided between the board holding part 2 and the image pickup part 5 is also provided at a position in which it does not interfere with the movement of the mounting head 31 and, in particular, on the movement pathway of the suction nozzle 33, and collects the electronic component 10 held by the suction nozzle 33 as necessary. Moreover, the component collecting mechanism 62 provided on the (+X) side of the stage 412 is moved integrally with the stage 412 in the X-direction and the Y-direction by the tray moving mechanism 413 and collects the electronic component 10 held by the feeding collet 421 as necessary.

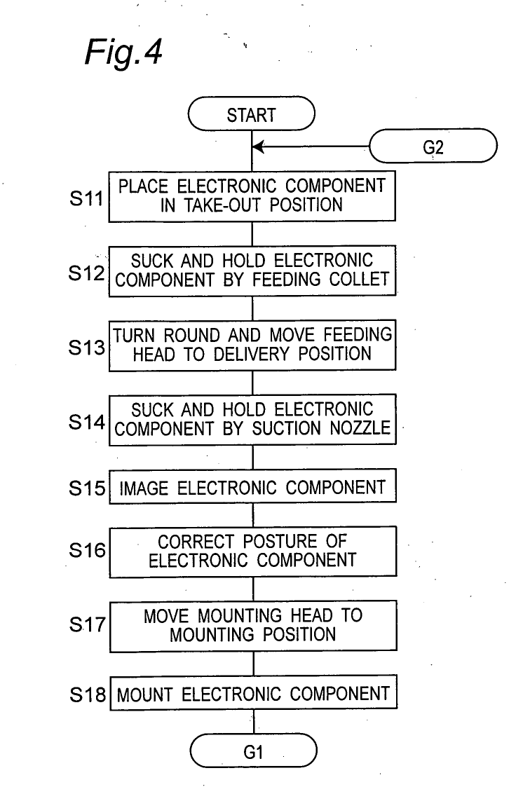

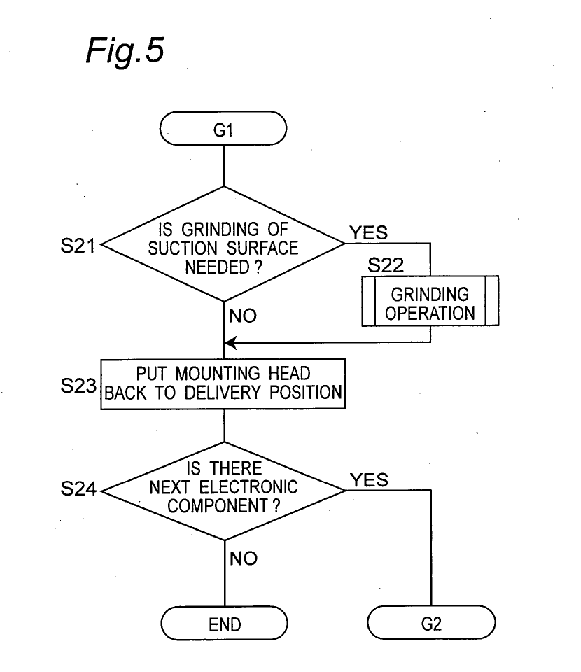

FIGS. 4 and 5 are charts showing the flow of the operation of the electronic component mounting apparatus 1. When the electronic component 10 is mounted on the circuit board 9 by the electronic component mounting apparatus 1, the component tray 411, on which numbers of electronic components 10 are mounted with the bonding surface 10a facing toward the (+Z) side, is first disposed below the feeding head 42 located on the (−X) side of FIG. 1 (step S11). Subsequently, the feeding collet 421 is moved down by the mechanism inside the feeding head 42, and the bonding surface 10a of the electronic component 10 on the component tray 411 is sucked and held by the feeding collet 421. Thereafter, the feeding collet 421 moves up and takes out the electronic component from the component tray 411 (step S12). A position of the feeding head 42 when the electronic component 10 is taken out by the feeding collet 421 and a position of the electronic component 10 to be taken out, i.e., the position just below the feeding collet 421 are each referred to as a “take-out position” 47.

Next, the feeding head 42, which is sucking and holding the electronic component 10, is moved in the (+X) direction by the feeding head moving mechanism 43 while being turned by 180 degrees clockwise in FIG. 1 by the turn mechanism 44 and positioned at a position indicated by the two-dot chain lines in FIG. 1 (step S13). At this time, the mounting head 31 is preparatorily located at a position indicated by the two-dot chain lines in FIG. 1, so that the feeding collet 421 of the feeding head 42 and the suction nozzle 33 of the mounting head 31 face each other. At the end of the feeding collet 421 facing in the (+Z) direction, the electronic component 10 is held with an upper surface 10c on the side opposite from the bonding surface 10a facing toward the (+Z) direction side.

Subsequently, the suction nozzle 33 is slightly moved down by the nozzle elevating mechanism 34, and the upper surface 10c of the electronic component 10 is sucked and held by the suction nozzle 33. Concurrently, the suction by the feeding collet 421 is stopped, and the suction nozzle 33 receives the electronic component 10 from the feeding collet 421 and sucks and holds the component by the suction surface 333 (step S14). Hereinafter, positions of the mounting head 31 and the feeding head 42 when the electronic component 10 is delivered from the feeding head 42 to the mounting head 31, i.e., when the component feeding is performed, i.e., the positions indicated by the two-dot chain lines in FIG. 1 are each referred to as a “delivery position” 48. It is noted that the feeding of the electronic component 10 may be performed by slightly moving up the feeding collet 421 that is holding the electronic component 10 instead of moving down the suction nozzle 33. Moreover, the relative position between the electronic component 10 held by the feeding collet 421 and the suction nozzle 33 may be finely adjusted by slightly moving the feeding collet 421 or the suction nozzle 33 in the horizontal direction in the delivery position 48.

When the feeding of the electronic component 10 is completed, the suction nozzle 33 is slightly moved up by the nozzle elevating mechanism 34 and put back to the original position, and the feeding head 42 is turned counterclockwise by the turn mechanism 44 while being moved in the (−X) direction by the feeding head moving mechanism 43 to retreat from the delivery position 48 to the take-out position 47. Concurrently with the retreat of the feeding head 42, the mounting head 31 moves to a position just above the image pickup part 5, and the electronic component 10 held by the suction surface 333 of the suction nozzle 33 is imaged by the image pickup part 5 (step S15).

Image data obtained by the imaging is transferred to the control part 8, and the obtained image data of the electronic component 10 and an image data of the electronic component 10 preparatorily stored in a storage section of the control part 8 are compared with each other to detect the posture, i.e., the holding state of the held electronic component 10. In the mounting mechanism 3, the mounting head 31 is controlled on the basis of the detected posture of the held electronic component 10, and the suction nozzle 33 is turned around the axis of the suction nozzle 33 to correct the posture of the held electronic component 10 (step S16). When it is determined that the posture of the held electronic component 10 is in an uncorrectable state, i.e., a suction error is occurring, the mounting operation of the electronic component 10 is stopped, and the mounting head 31 is moved to a position above the component collecting mechanism 61. The electronic component 10 separated from the suction nozzle 33 by air blow or the like through the suction nozzle 33 is collected by the component collecting mechanism 61.

Subsequently, the mounting head 31 is moved in the (+X) direction from the delivery position 48 indicated by the two-dot chain lines in FIG. 1 by the mounting head moving mechanism 32 and placed above a predetermined mounting position of the electronic component 10 on the circuit board 9 (step S17). It is noted that a position in the Y-direction of the circuit board 9 has preparatorily been adjusted by the stage moving mechanism 22.

Next, the suction nozzle 33 is moved down toward the circuit board 9 to bring the electrode portions 10b formed on the bonding surface 10a in contact with the electrodes on the circuit board 9, and the electronic component is pressurized against the circuit board 9 held by the board holding part 2 by the nozzle elevating mechanism 34. By applying ultrasonic vibrations to the suction nozzle 33 by the ultrasonic vibrator 334 in the above state, the electronic component 10 is electrically connected to the circuit board 9, and the bonding, i.e., mounting is carried out concurrently with the mounting of the electronic component 10 (step S18). Hereinafter, positions of the mounting head 31 and the circuit board 9 when the electronic component 10 is mounted on the circuit board 9 are each referred to as a “mounting position” 38.

Since the suction nozzle 33 is formed of stainless steel of a satisfactory vibration characteristic in the electronic component mounting apparatus 1, the ultrasonic vibrations from the ultrasonic vibrator 334 can efficiently be transmitted to the electronic component 10. Moreover, the suction surface 333 that sucks the electronic component 10 is formed to have a predetermined surface roughness of, for example, a centerline roughness (Ra) of 3 μm to 5 μm, so that slip between the electronic component 10 and the suction surface 333 is suppressed to efficiently transmit the ultrasonic vibrations. Therefore, the work efficiency of the mounting operation of the electronic component 10 and the bonding quality of the electronic component 10 to the circuit board 9 can be improved.

When the mounting operation of the electronic component 10 ends, the suction nozzle 33, which has stopped suction, is moved up apart from the electronic component 10 by the nozzle elevating mechanism 34. Then the suction by the suction nozzle 33 is carried out, and a pressure inside the suction passage is detected by the pressure sensor 36. The presence or absence of the electronic component 10 at the end of the suction nozzle 33, i.e., the occurrence or nonoccurrence of “bringback” of the electronic component 10 by a component mounting error is confirmed. In this case, when the bringback of the electronic component 10 is occurring, the mounting head 31 moves to the position above the component collecting mechanism 61, and the electronic component 10 held by the suction nozzle 33 is collected by the component collecting mechanism 61.

Subsequently, it is confirmed whether or not the suction surface 333 of the suction nozzle 33 needs to be ground by the control part 8 (step S21). When it is determined that the grinding is needed, grinding operation (step S22) is carried out. In the present embodiment, it is determined that the grinding is needed when the frequency of the mounting operation of the electronic component 10 carried out after the last grinding of the suction surface 333 reaches a predetermined frequency. As other determination methods, the determination can be made in a case where the suction surface 333 of the suction nozzle 33 is inclined, a case where an attachment to the suction surface 333 is detected or another case.

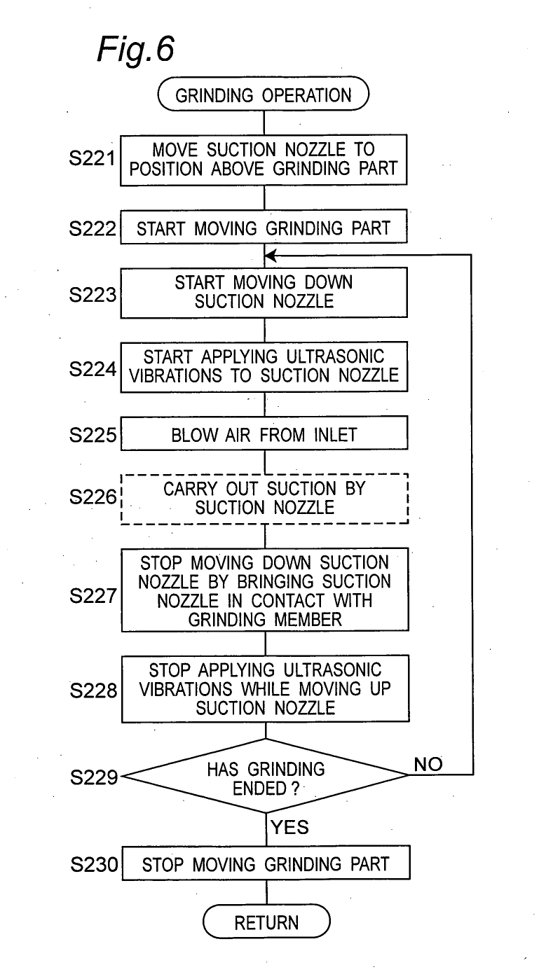

FIG. 6 is a view showing the flow of the grinding operation of the suction surface 333. When it is determined that the suction surface 333 needs to be ground by the control part 8, the suction nozzle 33 is moved in the (+X) direction by the mounting head moving mechanism 32 and placed above the grinding part 7, and a position in the Y-direction of the grinding part 7 is adjusted by the stage moving mechanism 22, achieving positional alignment between the grinding member 71 held by the grinding member holding part 72 and the suction nozzle 33 (step S221). Subsequently, movement in the (+Y) direction or the (−Y) direction of the grinding part 7 is started by the stage moving mechanism 22 under the control of the control part 8 (step S222), and the suction nozzle 33 is continuously moved in the (−Y) direction relative to the grinding part 7.

Subsequently, the suction nozzle 33 starts moving down toward the grinding part 7 of the suction nozzle 33 by the nozzle elevating mechanism 34 (step S223), and the downward movement is continued until the suction nozzle 33 comes in contact with the grinding member 71 held by the grinding part 7. During the downward movement of the suction nozzle 33, ultrasonic vibrations start being applied to the suction nozzle 33 by the ultrasonic vibrator 334 (step S224). At this time, the suction nozzle 33 is turned as necessary, so that a direction in which the ultrasonic vibrations are applied to the suction nozzle 33, i.e., the direction in which the suction surface 333 vibrates corresponds to the Y-direction that coincides with a direction in which the grinding member 71 moves. In this case, the reason why the direction of vibrations is made to coincide with the movement direction of the grinding member 71 is to prevent the deformation of the suction nozzle 33. Moreover, by carrying out both the movement of the grinding member 71 and the application of ultrasonic vibrations to the suction nozzle 33, the suction surface 333 of the suction nozzle 33 can be ground more effectively.

When the suction surface 333 of the suction nozzle 33 comes close to the grinding member 71, air is blown from the inlet 332 toward the grinding member 71 immediately before the suction surface 333 comes in contact with the grinding surface 711 of the grinding member 71. By this operation, foreign materials of abrasive powder and so on, which are generated by, for example, the last grinding operation and exist on the grinding member 71 below the suction surface 333 and its neighborhood, are removed (step S225). In the electronic component mounting apparatus 1, it is acceptable to further carry out suction through the inlet 332 immediately after the blow from the inlet 332 and immediately before the suction surface 333 comes in contact with the grinding surface 711 of the grinding member 71 (step S226). When the foreign materials below the suction nozzle 33 still remain unremoved only by the blow operation from the inlet 332, it is possible to further remove the remaining foreign materials by the suction operation of the suction nozzle 33 immediately before the grinding.

Immediately after the blow operation (and suction operation) through the inlet 332, contact of the suction surface 333 of the suction nozzle 33 with the grinding member 71 is detected by the load sensor 37 provided for the mounting head 31, and the downward movement of the suction nozzle 33 is stopped in a state in which a predetermined load is applied to the suction nozzle 33 that comes in contact with the grinding member 71, i.e., in a state in which the suction nozzle 33 is pressurized against the grinding member 71 with a predetermined force (step S227). In the present embodiment, a value of the load is about 0.1 N to 0.5 N as one example. In this case, the suction surface 333 of the suction nozzle 33 is vibrating with amplitude of about 2 μm by the ultrasonic vibrations applied from the ultrasonic vibrator 334, and the grinding surface 711 of the grinding member 71 is also moving in the (+Y) direction. Therefore, frictions occur between the suction surface 333 and the grinding surface 711, consequently grinding the suction surface 333.

When the grinding part 7 moves by a predetermined distance of, for example, about 1 mm in the present embodiment in the state in which the suction surface 333 is brought in contact with the grinding surface 711, the suction nozzle 33 is moved up apart from the grinding member 71 by the nozzle elevating mechanism 34, and the application of the ultrasonic vibrations from the ultrasonic vibrator 334 to the suction nozzle 33 is stopped (step S228). By this operation, one short-time grinding ends. As this case, duration of one grinding operation is specified by the movement distance of the grinding part 7 in the present embodiment, and the duration is about 30 ms as one example.

Subsequently, it is confirmed whether or not the grinding of the suction surface 333 has ended on the basis of the frequency of the short-time grinding carried out by the control part 8 (step S229). When it is determined that the grinding has not ended, the program flow returns to step S223 to repeat the short-time grinding operation. That is, the operation of starting moving down the suction nozzle 33, applying ultrasonic vibrations to the suction nozzle 33, stopping moving down the suction nozzle 33 by bringing the suction nozzle 33 in contact with the grinding member 71 immediately after the air blow and suction through the inlet 332 are carried out, moving the grinding part 7 by the specified distance, and thereafter stopping applying the ultrasonic vibrations while moving up the suction nozzle 33 is repeated (steps S223 through S229). In the repetitive operation, the grinding part 7 and the suction nozzle 33 are moved so that the suction surface 333 of the suction nozzle 33 comes in contact within a range of the grinding member 71. Moreover, the mounting head 31 is moved in the X-direction by the mounting head moving mechanism 32, and the grinding member 71 is moved in the Y-direction by the grinding part 7. Although only the grinding member 71 moves as described above during the grinding, the mounting head 31 is moved by the mounting head moving mechanism 32 after the one-time contact and grinding operation of the grinding member 71 with the suction nozzle 33 ends and the suction nozzle 33 is moved up. By this operation, the suction surface 333 can come in contact with a fresh portion of the grinding member 71 in the next grinding operation. Moreover, by changing the direction of movement of the grinding member 71, the suction surface 333 can be brought in contact without falling out of the range of the grinding member 71 as described above.

In the electronic component mounting apparatus 1, the short-time grinding operation as described in steps S223 through S229 is repeated by a predetermined frequency, i.e., 50 times in the present embodiment to grind the suction surface 333. By this operation, when the suction surface 333 is inclined with respect to the horizontal direction, a part, which projects in the (−Z) direction at the end of the suction nozzle 33, is abraded away to horizontally form the suction surface 333. When the surface roughness of the suction surface 333 falls out of a predetermined range, the surface roughness is put back within the predetermined range. Although the predetermined range cannot be specified since it depends on the roughness of the grinding member 71, the surface roughness is more accurate than that obtained by machining, as one example. Moreover, when the foreign materials are adhering to the suction surface 333, the foreign materials are removed. Subsequently, it is determined that the grinding of the suction nozzle 33 has ended by the control part 8, and the movement of the grinding part 7 stops to end the grinding operation of the suction nozzle 33 by the grinding part 7 (step S230).

When the grinding operation of the suction nozzle 33 ends or when it is determined that the suction nozzle 33 needs not to be ground by the control part 8 in step S21 of FIG. 5, the mounting head 31 moves to the delivery position 48 by the mounting head moving mechanism 32 (step S23). Subsequently, the presence or absence of the next electronic component 10 to be mounted on the circuit board 9 is determined by the control part 8 (step S24). When there is no next electronic component 10, the mounting operation ends. When there is the next electronic component 10, the program flow returns to step S11 to take out the electronic component 10 placed in the take-out position 47 and suck and hold the component by the suction surface 333 of the suction nozzle 33. Then, after the suction nozzle 33 is moved from the delivery position 48 to the mounting position 38, the operation of mounting electronic components 10 on the circuit board 9 is repeated. During the repetitive operation, the grinding operation of the suction surface 333 of the suction nozzle 33 is executed as necessary (steps S11 through S24).

Although the motions of the electronic component mounting apparatus 1 are sequentially carried out according to the description of the present embodiment in order to simplify the description, some of the motions are carried out parallel in order to practically reduce a cycle time (which is an average time required for mounting one electronic component 10 on the circuit board, and is also referred to as a “tact”). In concrete, the operation of imaging the electronic component 10 fed to the mounting head 31 and putting the mounting head 31 back to the delivery position 48 after the electronic component 10 is mounted by moving the mounting head 31 (steps S15 through S23) and the operation of moving the feeding head 42 to the delivery position 48 after the next electronic component 10 placed in the take-out position is sucked and held by the feeding collet 421 (steps S11 through S13) are carried out simultaneously. In this case, the determination of the presence or absence of the next electronic component 10 (step S24) is carried out before the imaging of the electronic component (step S15).

Moreover, when the bringback of the electronic component 10 by the feeding collet 421 due to a feeding error occurs in the feeding head 42, i.e., when the feeding of the electronic component 10 from the feeding collet 421 to the suction nozzle 33 ends in failure to cause a state in which the feeding collet 421 is still holding the electronic component 10, the component collecting mechanism 62 is moved by the tray moving mechanism 413 toward a position below the feeding collet 421 located at the take-out position 47, and the electronic component 10 held by the feeding collet 421 is collected.

As described above, in the electronic component mounting apparatus 1, the constituent parts of the nozzle elevating mechanism 34, the stage moving mechanism 22, the ultrasonic vibrator 334 and so on are controlled by the control part 8, so that the suction surface 333 of the suction nozzle 33 is brought in intermittent contact with the grinding surface 711 of the grinding member 71 while the suction nozzle 33 is continuously moved in the Y-direction relative to the grinding surface 711 of the grinding part 7 and the ultrasonic vibrations are applied in order to grind the suction surface 333. As described above, since the grinding operation is carried out intermittently by making the suction surface 333 bring into contact with the grinding surface 711, a comparatively long-time continuous force is prevented from being applied to the suction nozzle 33. Therefore, the suction surface 333 can be ground while preventing the large deformation of the suction nozzle 33.

Moreover, since the relative movement directions between the grinding surface 711 and the suction nozzle 33 are the Y-direction identical to the direction of vibration of the ultrasonic vibrations applied to the suction nozzle 33, i.e., the direction of vibration of the suction surface 333, it is possible to prevent a large stress from being applied to the suction nozzle 33 during the grinding of the suction nozzle 33 and more reliably prevent the large deformation of the suction nozzle 33. Furthermore, since the sheet-shaped grinding member 71 is easily reliably held on the grinding part 7 by the suction portion 722, the grinding of the suction surface 333 can be more accurately carried out.

In the electronic component mounting apparatus 1, the air blow and further suction through the inlet 332 are carried out immediately before the suction surface 333 comes in contact with the grinding surface 711 to remove the foreign materials on the grinding member 71, the foreign materials are prevented from adhering to the suction surface 333 when the suction surface 333 comes in contact with the grinding surface 711, i.e., when the suction surface 333 is ground. Moreover, by intermittently grinding the suction surface 333, the amount of abrasive powder generated during the grinding can be reduced.

Moreover, since the grinding part 7 continuously moves during the grinding of the suction nozzle 33 in the electronic component mounting apparatus 1, the suction surface 333 can always be ground by an unused portion of the grinding surface 711. Moreover, the grinding part 7 moves by a distance that is not smaller than a diameter of the suction nozzle 33 while the suction surface 333 is away from the grinding surface 711. With this arrangement, the suction surface 333 can be brought in contact with the unused portion of the grinding surface 711 when the suction surface 333 comes into contact with the grinding surface 711. Therefore, the grinding of the suction surface 333 can efficiently be achieved.

Moreover, the grinding of the suction surface 333 can be achieved in a short time by utilizing the ultrasonic vibrations, and the cycle time of the electronic component mounting apparatus 1 can be shortened. Furthermore, by using the ultrasonic vibrator 334 used for the mounting of the electronic components 10 also for the grinding of the suction surface 333, the construction of the electronic component mounting apparatus 1 can be simplified.

As described above, the electronic component mounting apparatus 1 is suitable particularly for the mounting of semiconductor light-emitting devices such as a bare chip (so-called a LED chip) of a light-emitting diode, a semiconductor laser and so on, of which the cycle time is required to be shortened. Moreover, in the electronic component mounting apparatus 1, which carries out mounting by using the ultrasonic waves of a short time required for fixing the electronic component during the mounting, the simplification of the construction of the apparatus and the reduction in the cycle time are particularly preferable.

The one embodiment of the present invention has been described above. The present invention is not limited to the aforementioned embodiment but allowed to be modified in various ways.

For example, during the grinding operation of the suction surface 333 shown in FIG. 6, the operation of starting applying the ultrasonic vibrations to the suction nozzle 33 (step S224) and the operation of air blow and suction through the suction nozzle 33 (steps S225 and S226) may be exchanged in order.

The vibrations applied to the suction nozzle 33 in the grinding operation of the suction surface 333 should preferably be ultrasonic vibrations from the viewpoint of carrying out the grinding of the suction surface 333 in a short time. However, vibrations other than the ultrasonic vibrations are acceptable so long as the suction surface 333 can be ground while preventing the large deformation of the suction nozzle 33.

Moreover, although the ultrasonic vibrations are applied to the suction nozzle 33 in the present embodiment, it is acceptable to adopt a construction in which the ultrasonic vibrations are not applied. That is, in order to carry out the grinding of the suction surface while preventing the large deformation of the component holding member, which is the object of the present invention, it is proper to move the component holding member and the grinding surface 711 of the grinding member 71 relative to each other in the mutually parallel directions.

In the grinding part 7, it is acceptable to move the grinding surface 711 with respect to the suction nozzle 33 in a construction that a tape-shaped grinding member 71 is held by being wound around two rollers, and the grinding member 71 is fed from one roller and is wound around the other roller. Moreover, it is acceptable to move the suction nozzle 33 in the Y-direction in a state in which the grinding member 71 is fixed.

Moreover, although the construction in which the suction nozzle 33 is moved up and down by the nozzle elevating mechanism 34 in the grinding operation of the suction surface 333 is adopted, it is acceptable to adopt a construction in which the grinding member 71 is moved up and down in the Z-direction. What is essential is that the suction nozzle 33 and the grinding member 71 are required to move up and down relative to each other in the Z-direction.

Moreover, the mounting of electronic components, which should preferably be carried out by the method of applying the ultrasonic vibrations from the viewpoint of the simplification of the apparatus construction in the electronic component mounting apparatus 1, may be carried out by another method. For example, it is acceptable to electrically connect the electrode portions 10b of the electronic component 10 with the electrodes of the circuit board 9 via plating solder preparatorily formed on the circuit board 9 or the electronic components or via an anisotropic conductive film or a nonconductive resin film.

The electronic component mounting apparatus 1 is suitable also for the mounting of various kinds of electronic components of, for example, semiconductor bare chip components, SAW (Surface Acoustic Wave) filters and so on.

It is to be noted that, by properly combining the arbitrary embodiments of the aforementioned various embodiments, the effects possessed by them can be produced.

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

The entire disclosure of Japanese Patent Application No. 2004-139576 filed on May 10, 2004, including specification, drawings, and claims is incorporated herein by reference in its entirety.

1. An electronic component mounting apparatus for mounting an electronic component on a circuit board, the apparatus comprising:
a component holding member configured to suck and hold the electronic component with a suction surface, and mount the electronic component on the circuit board;
a grinding member configured to have a grinding surface;
an elevating mechanism configured to move up and down the component holding member and the grinding surface relative to each other;
a moving mechanism configured to move the component holding member and the grinding surface relative to each other in mutually parallel movement directions; and
a control part configured to bring the suction surface in intermittent contact with the grinding member while moving the component holding member and the grinding member relative to each other in the movement directions by controlling the elevating mechanism and the moving mechanism.

2. The electronic component mounting apparatus as claimed in claim 1, wherein
the apparatus further comprises an oscillation part configured to apply vibrations to the component holding member, and
the control part controls the oscillation part to bring the suction surface in intermittent contact with the grinding member and apply vibrations to the component holding member.

3. The electronic component mounting apparatus as claimed in claim 1, wherein
the grinding member has a sheet-like shape, and the apparatus further comprises a grinding member holding part configured to have a flat surface portion to be brought in contact with a center portion of the grinding member used for grinding and a suction portion configured to suck and hold the grinding member by a periphery of the center portion.

4. The electronic component mounting apparatus as claimed in claim 2, wherein
the oscillation part is an ultrasonic vibrator, and
the elevating mechanism pressurizes the electronic component held by the component holding member against the circuit board, and the ultrasonic vibrator applies ultrasonic vibrations to the electronic component when the electronic component is connected electrically to the circuit board.

5. The electronic component mounting apparatus as claimed in claim 3, wherein
the oscillation part is an ultrasonic vibrator, and
the elevating mechanism pressurizes the electronic component held by the component holding member against the circuit board, and the ultrasonic vibrator applies ultrasonic vibrations to the electronic component when the electronic component is connected electrically to the circuit board.

6. The electronic component mounting apparatus as claimed in claim 2, wherein
the movement direction coincides with a direction in which the suction surface vibrates.

7. The electronic component mounting apparatus as claimed in claim 3, wherein
the movement direction coincides with a direction in which the suction surface vibrates.

8. The electronic component mounting apparatus as claimed in claim 4, wherein
the movement direction coincides with a direction in which the suction surface vibrates.

9. The electronic component mounting apparatus as claimed in claim 5, wherein
the movement direction coincides with a direction in which the suction surface vibrates.

10. The electronic component mounting apparatus as claimed in claim 1, wherein
the electronic component is a semiconductor light-emitting device.

11. An electronic component mounting method for mounting an electronic component on a circuit board, the method comprising:
mounting the electronic component on the circuit board by a board holding member that sucks and holds the electronic component with a suction surface at which an inlet is formed; and
bringing the suction surface in contact with a grinding member while moving the grinding member that has a grinding surface configured to grind the suction surface and the component holding member relative to each other in mutually parallel directions while mounting operation of the electronic component is repeated.

12. The electronic component mounting method as claimed in claim 11, wherein
vibrations are applied to the component holding member when the suction surface is brought in contact with the grinding member.

13. The electronic component mounting method as claimed in claim 11, wherein
a gas is blown from the inlet toward the grinding member immediately before the suction surface is brought in contact with the grinding member.

14. The electronic component mounting method as claimed in claim 12, wherein
a gas is blown from the inlet toward the grinding member immediately before the suction surface is brought in contact with the grinding member.

15. The electronic component mounting method as claimed in claim 13, wherein
suction through the inlet is carried out immediately after the gas is blown and immediately before the suction surface is brought in contact with the grinding member.

16. The electronic component mounting method as claimed in claim 14, wherein
suction through the inlet is carried out immediately after the gas is blown and immediately before the suction surface is brought in contact with the grinding member.
